(19) United States
(12) Patent Application Publication
(10) Pub. No.: US 2004/0070165 A1
(43) Pub. Date: Apr. 15, 2004

(54) Learning-aid bicycle

(76) Inventors: Joerg Liebetrau, Bergisch Gladbach (DE); Joerg Frohn, Frechen (DE)

Correspondence Address: CHARLES E. BAXLEY, Hart, Baxley, Daniels & Holton, 90 John Street, Third Floor, New York, NY, 10038, US

(21) Appl. No.: 10/270,901

(22) Filed: Oct. 15, 2002

(51) Int. Cl. B62M 1/02

(52) U.S. Cl. 280/259

(57) ABSTRACT

A learning-aid bicycle includes a main body, a connecting member, and a pedal set. In practice, the connecting member may be detached from the connecting portion of the main body, so that the pedal set is detached from the main body. Thus, the learner, such as the child, may be seated on the main body, with his two feet stepped on the ground, so as to ride and move the bicycle by his two feet, so that the learner may learn how to operate, maneuver, manipulate and balance the bicycle, without having to step on the cranks of the pedal set to ride and move the bicycle, thereby preventing the learner from failing down from the bicycle, and thereby protecting the learner's safety.

### BACKGROUND OF THE INVENTION

1. Field of the Invention

The present invention relates to a learning-aid bicycle, and more particularly to a learning-aid bicycle, wherein the pedal set may be detached from the main body of the bicycle so that the learner may learn how to operate, maneuver, manipulate and balance the bicycle, without having to step on the cranks of the pedal set to ride and move the bicycle, thereby preventing the learner from falling down from the bicycle, and thereby protecting the learner's safety.

2. Description of the Related Art

A conventional learning-aid bicycle comprises two auxiliary wheels which are mounted beside the two rear wheels of the bicycle. However, when the learner, such as the child, loses his balance during the riding process, his one foot will has to step on the ground, so that the pedal easily hit the child's one foot, thereby causing danger to or injuring the child. In addition, the child easily relies on the two auxiliary wheels during the riding process, thereby decreasing the learning effect of riding the bicycle. Further, the child excessively relies on the two auxiliary wheels during the riding process, thereby increasing the oblique angle between the two auxiliary wheels and the bicycle, so that the bicycle easily turns over.

### SUMMARY OF THE INVENTION

The present invention has arisen to mitigate and/or obviate the disadvantage of the conventional learning-aid bicycle.

The primary objective of the present invention is to provide a learning-aid bicycle, wherein the fixing post of the connecting member may be detached from the receiving space of the connecting portion of the main body of the bicycle, so that the pedal set is detached from the main body. Thus, the learner, such as the child, may be seated on the main body, with his two feet stepped on the ground, so as to ride and move the bicycle by his two feet, so that the learner may learn how to operate, maneuver, manipulate and balance the bicycle, without having to step on the cranks of the pedal set to ride and move the bicycle, thereby preventing the learner from falling down from the bicycle, and thereby protecting the learner's safety.

Another objective of the present invention is to provide a learning-aid bicycle, wherein after the learner is skilled to ride and move the bicycle, the fixing post of the connecting member may be fixed in the receiving space of the connecting portion of the main body, so that the pedal set is attached to the main body. Thus, the learner may ride and move the bicycle in a normal manner.

In accordance with the present invention, there is provided a learning-aid bicycle, comprising a main body, a connecting member, and a pedal set, wherein:

the main body has a mediate portion having a bottom secured with a connecting portion, the connecting portion of the main body has an inner wall formed with a receiving space;

the connecting member is detachably mounted on the connecting portion of the main body, and includes a fixing post and a pivot portion secured on a lower end of the fixing post, the fixing post of the connecting member is inserted into the receiving space of the connecting portion of the main body; and

the pedal set is pivotally mounted on the connecting member.

Further benefits and advantages of the present invention will become apparent after a careful reading of the detailed description with appropriate reference to the accompanying drawings.

### BRIEF DESCRIPTION OF THE DRAWINGS

FIG. 1 is a side plan exploded view of a learning-aid bicycle in accordance with a preferred embodiment of the present invention;

FIG. 2 is a partially cut-away exploded perspective view of the learning-aid bicycle in accordance with the preferred embodiment of the present invention; and

FIG. 3 is an assembly view of the learning-aid bicycle as shown in FIG. 1.

### DETAILED DESCRIPTION OF THE INVENTION

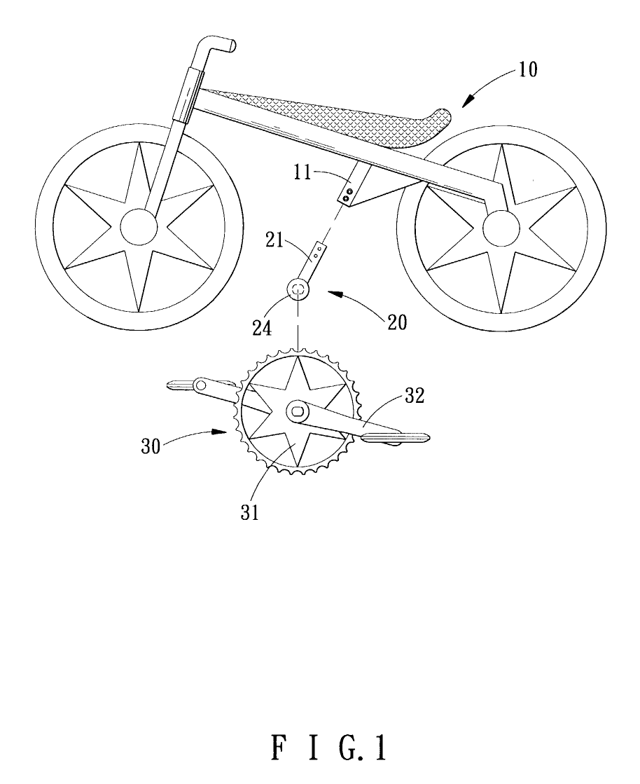

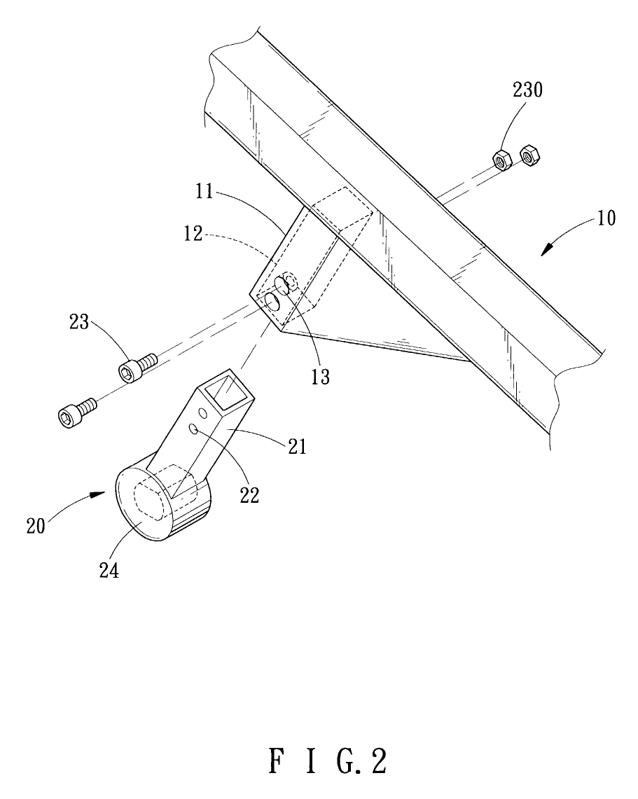

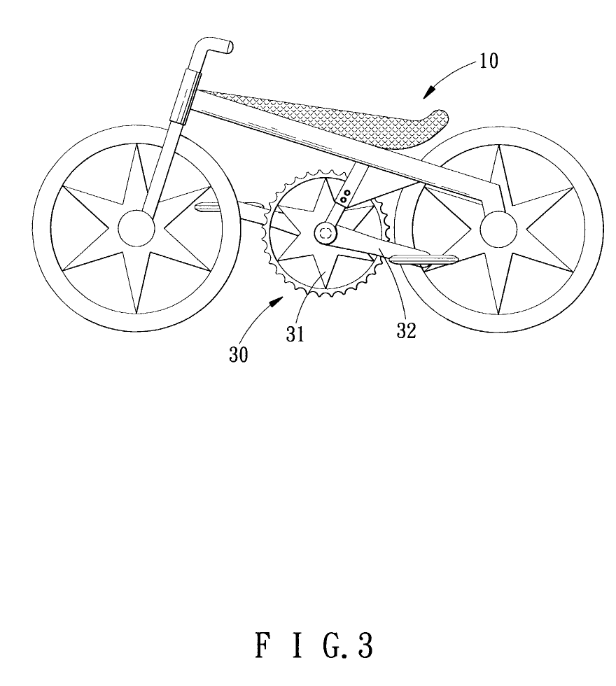

Referring to FIGS. 1-3, a learning-aid bicycle in accordance with a preferred embodiment of the present invention comprises a main body 10, a connecting member 20, and a pedal set 30.

The main body 10 has a mediate portion having a bottom secured with a connecting portion 11. The connecting portion 11 of the main body 10 has an inner wall formed with a receiving space 12, and has two opposite sides each formed with two through holes 13 each communicating with the receiving space 12.

The connecting member 20 is detachably mounted on the connecting portion 11 of the main body 10, and includes a fixing post 21 and a pivot portion 24 secured on a lower end of the fixing post 21. The fixing post 21 of the connecting member 20 is inserted into the receiving space 12 of the connecting portion 11 of the main body 10, and has an upper end having two opposite sides each formed with two through holes 22 each aligning with a respective one of the two through holes 13 of each of the two opposite sides of the connecting portion 11 of the main body 10.

The learning-aid bicycle further comprises two locking screws 23 each extended through a respective one of the two through holes 13 of each of the two opposite sides of the connecting portion 11 of the main body 10 and a respective one of the two through holes 22 of each of the two opposite sides of the fixing post 21 of the connecting member 20, and is locked with one of two locking nuts 230, so that the fixing post 21 of the connecting member 20 is fixed on the connecting portion 11 of the main body 10.

The pedal set 30 is pivotally mounted on the connecting member 20, and includes a chainwheel 31 pivotally mounted on the pivot portion 24 of the connecting member 20, and two cranks 32 each secured on the chainwheel 31.

In practice, the fixing post 21 of the connecting member 20 may be detached from the receiving space 12 of the connecting portion 11 of the main body 10, so that the pedal set 30 is detached from the main body 10. Thus, the learner, such as the child, may be seated on the main body 10, with his two feet stepped on the ground, so as to ride and move the bicycle by his two feet, so that the learner may learn how to operate, maneuver, manipulate and balance the bicycle, without having to step on the cranks 32 of the pedal set 30 to ride and move the bicycle, thereby preventing the learner from falling down from the main body 10 of the bicycle, and thereby protecting the learner's safety.

After the learner is skilled to ride and move the bicycle, the fixing post 21 of the connecting member 20 may be fixed in the receiving space 12 of the connecting portion 11 of the main body 10, so that the pedal set 30 is attached to the main body 10. Thus, the learner may ride and move the bicycle in a normal manner.

While the preferred embodiment(s) of the present invention has been shown and described, it will be apparent to those skilled in the art that various modifications may be made in the embodiment without departing from the spirit of the present invention. Such modifications are all within the scope of the present invention.

What is claimed is:

1. A learning-aid bicycle, comprising a main body, a connecting member, and a pedal set, wherein:
the main body has a mediate portion having a bottom secured with a connecting portion, the connecting portion of the main body has an inner wall formed with a receiving space;
the connecting member is detachably mounted on the connecting portion of the main body, and includes a fixing post and a pivot portion secured on a lower end of the fixing post, the fixing post of the connecting member is inserted into the receiving space of the connecting portion of the main body; and
the pedal set is pivotally mounted on the connecting member.

2. The learning-aid bicycle in accordance with claim 1, wherein:
the connecting portion of the main body has two opposite sides each formed with two through holes each communicating with the receiving space;
the fixing post of the connecting member has an upper end having two opposite sides each formed with two through holes each aligning with a respective one of the two through holes of each of the two opposite sides of the connecting portion of the main body; and
the learning-aid bicycle further comprises two locking screws each extended through a respective one of the two through holes of each of the two opposite sides of the connecting portion of the main body and a respective one of the two through holes of each of the two opposite sides of the fixing post of the connecting member, and is locked with one of two locking nuts, so that the fixing post of the connecting member is fixed on the connecting portion of the main body.

3. The learning-aid bicycle in accordance with claim 1, wherein the pedal set includes a chainwheel pivotally mounted on the pivot portion of the connecting member, and two cranks each secured on the chainwheel.
